(19) United States
(12) Patent Application Publication
(10) Pub. No.: US 2026/0302661 A1
(43) Pub. Date: Oct. 1, 2026

(54) PCB TERMINAL PROTECTION STRUCTURE AND ASSEMBLY METHOD USING RECEPTACLE CONNECTOR HAVING PCB TERMINAL PROTECTOR

(71) Applicant: Hyundai Kefico Corporation, Gunpo (KR)

(72) Inventor: Min-Su Lee, Gunpo (KR)

(21) Appl. No.: 19/577,885

(22) Filed: Mar. 25, 2026

(30) Foreign Application Priority Data
Mar. 26, 2025 (KR) 10-2025-0038712

(51) Int. Cl. H01R 12/70; H01R 12/72; H01R 43/20

(52) U.S. Cl. CPC H01R 12/7047; H01R 12/722; H01R 43/205

(57) ABSTRACT

In a receptacle connector having a printed circuit board (PCB) terminal protector, a protector is coupled to receptacle terminals and soldered to a connector board. The protector may be injection-molded together with an body into which the receptacle terminals are inserted and left/right protector fixing devices having mutually orthogonal bolt fastening directions. As a result, it is possible to improve vibration resistance through structural stability of an integrated structure of the protector and the connector board, which surrounds the PCB-side receptacle terminals, and also improving assemblability with other components by the protector.

### CROSS REFERENCE TO RELATED APPLICATION

The present application claims under 35 U.S.C. §119(a) the benefit of Korean Patent Application No. 10-2025-0038712, filed Mar. 26, 2025, the entire contents of which are incorporated by reference herein.

### BACKGROUND

### Technical Field

The present disclosure relates to a receptacle connector, more particularly, to a printed circuit board (PCB) terminal protection structure and an assembly method using the receptacle connector, in which a PCB terminal protector is provided to ensure structural stability.

### Description of the Related Art

Typically, a receptacle connector includes a printed circuit board (PCB) having a receptacle as a terminal, and a plug connector having a connector blade configured to be fitted into the receptacle.

Accordingly, the receptacle connector may be selectively connected and disconnected in response to the receptacle mounted on the PCB to facilitate data communication with an external device or power supply from a power supply unit.

However, since the receptacle connector does not support the receptacle of the PCB, it is difficult to ensure the structural stability of the receptacle when the connector blade of the plug connector is assembled to a receptacle terminal and the receptacle connector is vulnerable to vibration, and in particular, the assemblability of the connector blade is poor.

In addition, the PCB terminal protection structure using the receptacle connector includes a connector board, a board 1 (or a housing board), a connector guide, a busbar assembly (or an insert-molded busbar), a receptacle terminal, a guide screw, a board screw, a connector, and a connector screw, and assembly of these components is achieved by inserting the busbar assembly and the receptacle terminal into the connector board, soldering a busbar end portion and a terminal end portion to the connector board, assembling the connector guide connected to the receptacle terminal of the connector board using the guide screw, subsequently seating the board 1 in a housing and assembling the connector board thereto using the board screw, and then fastening the connector to the connector guide.

However, in the PCB terminal protection structure and the assembly method using the receptacle connector, a large number of components including the connector guide, the busbar assembly, the receptacle terminal, and the plurality of screws are required for assembling the connector board and the board 1, and in particular, due to tolerances or the like of the numerous connector-related components, there is a problem in that it is difficult to improve assemblability between the components.

### SUMMARY

The present disclosure is directed to providing a receptacle connector having a printed circuit board (PCB) terminal protector, in which a protector is integrally formed with a PCB and is assembled to a housing while surrounding a receptacle terminal on a PCB side, thereby improving vibration resistance through enhanced structural stability of the receptacle terminal, and in particular, improving connector assemblability by guiding blade insertion of a connector using the protector.

In addition, the present disclosure is directed to providing a PCB terminal protection structure and an assembly method using a receptacle connector having a PCB terminal protector, in which a receptacle terminal soldered together with a connector board and a busbar and a connector guide are integrated into a single structure, and a board 1 is soldered to the connector board and then assembled to a housing using screws, thereby improving assemblability through an integrated structure and a simplified component configuration.

According to the present disclosure, there is provided a printed circuit board (PCB) terminal protector comprising a connector board and a protector coupled to the connector board, wherein the protector includes a protector fixing device of an body configured to protect the receptacle terminal, an fastener configured to fasten the protector fixing device and the connector board, and a compression limiter configured to fasten the protector fixing device and the connector board to a housing.

According to one aspect of the present disclosure, there is provided a printed circuit board (PCB) terminal protector, including: a connector board; and a protector for protecting a receptacle terminal of the connector board, wherein the protector includes: a protector fixing device of a body (e.g., an injection-molded body) configured to protect the receptacle terminal; a fastener (e.g., an insert nut) configured to fasten the protector fixing device and the connector board; and a compression limiter configured to fasten the protector fixing device and a housing in which the connector board is located.

The fastener and the compression limiter may each provide a fastening place of a bolt and have fastening directions orthogonal to each other.

The protector fixing device may include a left protector fixing device and a right protector fixing device formed on left and right sides of the body.

The body may be formed with a PCB assembly guide which forms a gap with the connector board and formed with a first receptacle terminal insertion port in a hole structure into which the receptacle terminal of the connector board is inserted, a chamfered hole in the first receptacle terminal insertion port may have a chamfered structure, and an inlet of the first receptacle terminal insertion port may be covered by a connector assembly guide protruding from the body.

The body may form a second receptacle terminal insertion port, a receptacle terminal having a different specification from the receptacle terminal may be inserted into the second receptacle terminal insertion port, and an outlet of the second receptacle terminal insertion port may be covered by a connector separation wall of the body.

According to the present disclosure, there is provided a receptacle connector including a connector board, a protector coupled to a front of the connector board, and a housing coupled to a rear of the connector board, wherein the protector includes a left protector fixing device and a right protector fixing device of an body, which protect a receptacle terminal of the connector board, an fastener configured to fasten the left protector fixing device and the right protector fixing device to the connector board, and a compression limiter configured to fasten the left protector fixing device and the right protector fixing device to the housing, the fastener is coupled to a printed circuit board (PCB) bolt, and the compression limiter is coupled to a housing bolt.

The PCB bolt and the housing bolt may be formed to have fastening directions orthogonal to each other.

The body may have a first receptacle terminal insertion port in a hole structure into which the receptacle terminal of the connector board is inserted, a connector assembly guide surrounding a periphery of the first receptacle terminal insertion port may be formed in a protruding structure, and a chamfered hole of the first receptacle terminal insertion port may have a chamfered structure.

According to the present disclosure, there is provided a printed circuit board (PCB) terminal protection structure using a receptacle connector having a PCB terminal protector, the PCB terminal protection structure including a connector board in which a receptacle terminal and a busbar inserted into a busbar body are inserted and fixed by soldering, a housing having a connector connection housing in which a busbar locating portion couples a screw insertion portion of the busbar body and protrudes from an internal space in which the connector board is accommodated, a housing board in which the busbar is inserted and fixed by soldering at a portion of the connector connection housing, and a busbar screw located in the screw insertion portion and screw-fastened to the busbar locating portion to fix the busbar body.

The connector board may be connected to a plug connector, the plug connector may be assembled to a protector connected to the receptacle terminal, and a guide may be located between the protector and the plug connector to guide a fastening direction of the plug connector.

The busbar body may form a screw retaining protrusion in an internal space of the screw insertion portion, and the screw retaining protrusion may limit a screw fastening depth between the busbar screw and the busbar locating portion.

The housing board may form a board hole 121 into which the screw insertion portion of the busbar body is fitted.

According to the present disclosure, there is provided a method of assembling a printed circuit board (PCB) terminal using a receptacle connector having a PCB terminal protector, the method including steps of: forming an integrated component by coupling a busbar of a busbar body and a housing board with a connector board to which the busbar body is coupled together with a protector; coupling the integrated component to a housing; fastening a busbar screw to a connector connection housing in a screw insertion portion of the busbar body; fixing the busbar body to the connector connection housing; and assembling a plug connector to the protector.

According to another aspect of the present disclosure, there is provided a method of assembling a printed circuit board (PCB) terminal using a receptacle terminal having a PCB terminal protector, which includes forming an integrated component by fixing receptacle terminal end portions of receptacle terminals inserted into a connector board and protruding from one side of the connector board by soldering, locating a busbar body on the connector board at soldering portions of the receptacle terminal end portions, fixing busbar end portions of busbars protruding from an opposite side of the connector board by soldering, and then assembling a protector onto the receptacle terminals, and fixing the housing board fitted into the busbars protruding upward from the busbar body to the busbar end portions by soldering, coupling the integrated component with a housing, and fastening a busbar screw through a screw insertion portion of the busbar body to a busbar locating portion of a connector connection housing such that the busbar body is fixed to the connector connection housing, and assembling a plug connector to the protector at the connector connection housing side.

### BRIEF DESCRIPTION OF THE DRAWINGS

FIG. 1 is a configuration diagram of a receptacle connector having a printed circuit board (PCB) terminal protector according to the present disclosure.

FIG. 2 illustrates an assembled state of a PCB terminal, a protector, and a connector according to the present disclosure.

FIG. 3 is a cross-sectional view of the assembled protector and connector according to the present disclosure.

FIG. 4 illustrates a PCB terminal assembly structure using a receptacle connector having a PCB terminal protector according to the present disclosure.

FIGS. 5 and 6 illustrate examples of a method of assembling a PCB terminal using a receptacle connector having a PCB terminal protector according to the present disclosure.

### DETAILED DESCRIPTION OF THE DISCLOSURE

The terminology used herein is for the purpose of describing particular embodiments only and is not intended to be limiting of the present disclosure. As used herein, the singular forms "a," "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, various embodiments of the present disclosure will be described in detail with reference to the accompanying drawings, and these embodiments are examples and can be implemented in various different forms by those skilled in the art to which the present disclosure pertains, and thus are not limited to embodiments disclosed herein.

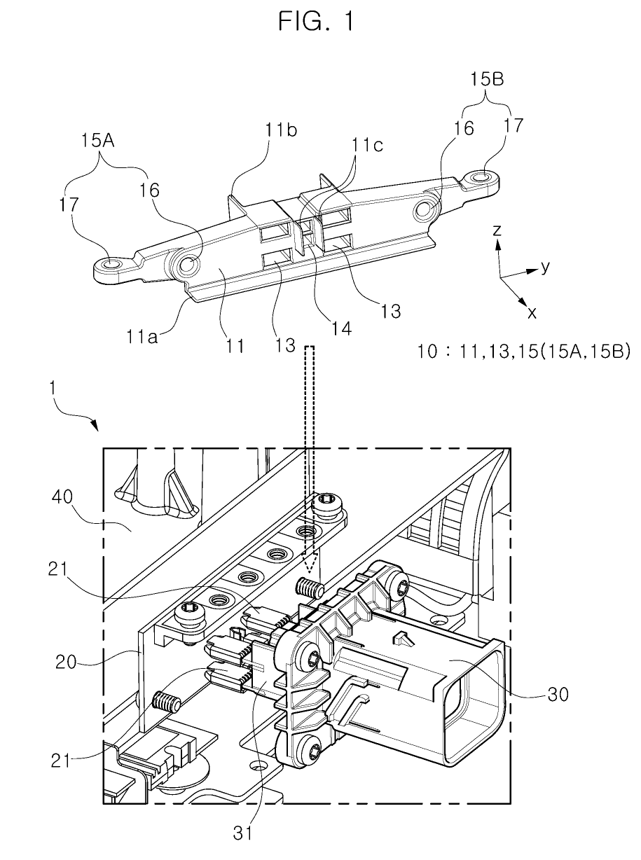

Referring to FIG. 1, a receptacle connector 1 includes a protector 10, a connector board (or a printed circuit board (PCB)) 20, and a plug connector 30, and the protector 10 is assembled into a housing 40 by inserting a receptacle terminal 21 therein and becoming integrated with the connector board 20 (i.e., a PCB assembly).

Accordingly, the receptacle connector 1 has a PCB terminal protector that can improve vibration resistance by securing structural stability of the receptacle terminal 21 of the connector board 20.

Specifically, the protector 10 is injection-molded into a rectangular body 11 (e.g., an injection-molded body) including insertion ports 13 and 14 and a protector fixing device 15. In this case, the rectangle has an elongated form with a length (i.e., along a y-axis of the xyz coordinates) greater than a width (i.e., along a z-axis of the xyz coordinates).

For example, the body 11 forms the insertion ports 13 and 14 in a central section of the entire length and forms the protector fixing device 15 in left and right sections.

In addition, the body 11 forms a PCB assembly guide 11a that protrudes horizontally (i.e., an x-axis of the xyz coordinate) toward a rear surface of the body below the insertion ports 13 and 14 and forms connector assembly guides 11b, which are two vertical walls that protrude vertically (i.e., the z-axis of the xyz coordinate) toward a front surface of the body, in left and right sides outside the insertion ports 13 and 14. In this case, the front surface of the body faces the plug connector 30, and the rear surface of the body faces the connector board 20.

In addition, the body 11 forms two vertical walls, that is, connector separation walls 11c, which protrude horizontally (i.e., the x-axis of the xyz coordinates) toward the rear surface of the body, in left and right sides inside the insertion ports 13 and 14.

Accordingly, when the protector 10 is assembled with the connector board 20, the PCB assembly guide 11a is located to form a gap with the connector board 20 in a protruding structure on a lower portion of the body 11.

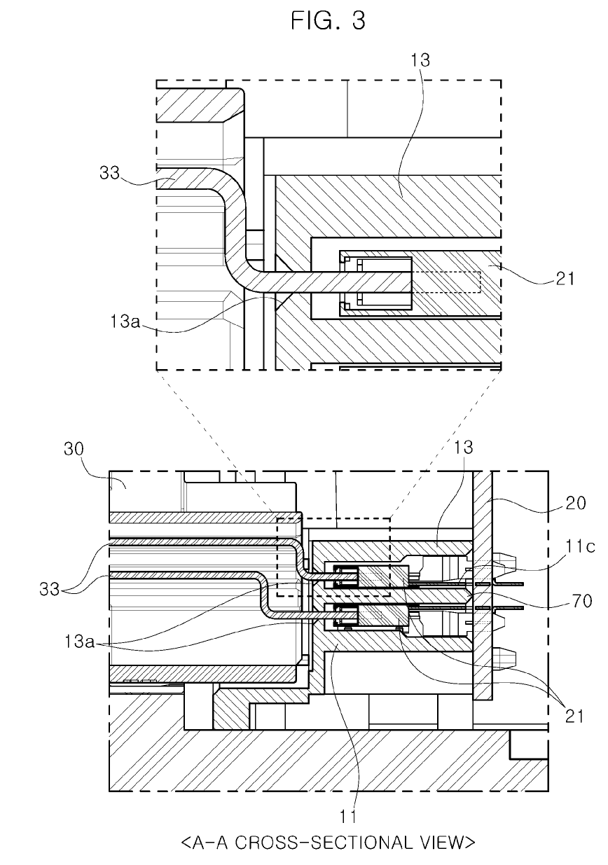

Then, the protector 10 guides the receptacle terminal 21 using the connector assembly guide 11b and surrounds the terminal connection portion 31 of the plug connector 30, and guides a screw 70 (see FIG. 3) on the plug connector 30 using the connector separation walls 11c.

In addition, the insertion ports 13 and 14 include a first receptacle terminal insertion port 13 having four holes and a second receptacle terminal insertion port 14 having two holes. In this case, the number of holes in the first receptacle terminal insertion port 13 varies depending on the number of receptacle terminals 21.

The four holes in the first receptacle terminal insertion port 13 are separated into two holes arranged vertically in left and right sides of the second receptacle terminal insertion port 14. The two holes of the second receptacle terminal insertion port 14 are arranged vertically in a middle region of the first receptacle terminal insertion port 13.

Accordingly, four holes of the first receptacle terminal insertion port 13 are protected by the protruding structure of the connector assembly guide 11b, and two holes of the second receptacle terminal insertion port 14 are protected by the protruding structure of the connector separation wall 11c.

Meanwhile, the protector fixing device 15 includes a fastener 16 (e.g., an insert nut) and a compression limiter 17 that are injection-molded together with the body 11.

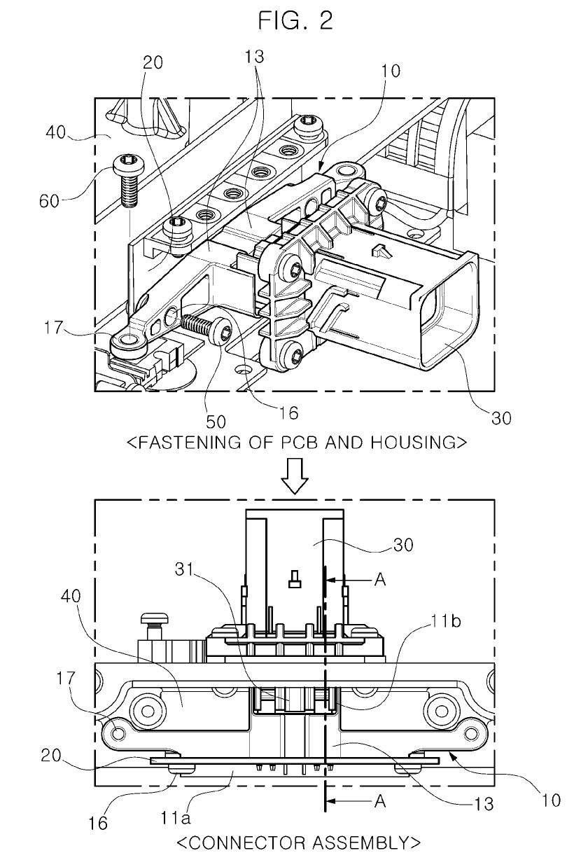

The fastener 16 is coupled with a PCB bolt 50 (see FIG. 2) to fasten the protector 10 to the housing 40 at the connector board 20 side. The compression limiter 17 is coupled with the housing bolt 60 (see FIG. 2) to allow the protector 10 to be fastened to the housing 40 at the connector board 20 side.

In particular, the fastener 16 and the compression limiter 17 have fastening directions that are orthogonal to each other, and to this end, the fastener 16 forms a horizontal (i.e., the x-axis of the xyz coordinate) fastening inlet hole, while the compression limiter 17 forms a vertical (i.e., the z-axis of the xyz coordinate) fastening inlet hole.

In addition, the protector fixing device 15 is configured as two units, that is, a left protector fixing device 15A and a right protector fixing device 15B, on the body 11 to ensure a stable fixing force to the connector board 20 and the housing 40. In this case, the left/right protector fixing devices 15A and 15B have the same structure including the fastener 16 and the compression limiter 17.

For example, the connector board 20 includes the receptacle terminal 21 electrically connected to a circuit and a device for performing the receptacle connector function, and the receptacle terminal 21 is soldered to the connector board 20. In this case, the connector board 20 is bolt-fastened to the housing 40 such that the receptacle terminal 21 faces the plug connector 30.

For example, the plug connector 30 includes a terminal connection portion 31 protruding forward and a plurality of connector blades 33 located therein.

The terminal connection portion 31 is surrounded by the connector assembly guide 11b of the protector 10 to stably guide the insertion direction of the connector blade 33 into the receptacle terminal 21. The connector blades 33 are fitted into the receptacle terminal 21 in a number corresponding to the number of terminals and assembled with the connector board 20.

For example, the housing 40 is a component of a power device having a receptacle connector 1 through which the plug connector 30 is disconnected and connected. In this case, the power device may be a power conversion device such as an integrated charging control unit (ICCU), an on board charger (OBC), a direct current/direct current (DCDC) converter, etc.

Meanwhile, FIGS. 2 and 3 illustrate the assembled state of the receptacle connector 1. In this case, since the plug connector 30 is only an example of a component to which the protector 10 is applied, it is apparent that the plug connector 30 does not limit the use of the protector 10 of the present disclosure.

Referring to FIG. 2, the receptacle connector 1 is configured as a PCB assembly by integrating the protector 10 and connector board 20 prior to being assembled into the housing 40.

For example, the protector 10 is configured as a PCB assembly simply by inserting the first receptacle terminal insertion port 13 into the receptacle terminal 21 of the connector board 20.

In this PCB assembly state, the PCB assembly guide 11a of the protector 10 forms a gap with the connector board 20 by protruding from the lower portion of the body 11, and the connector assembly guide 11b of the protector 10 surrounds left and right sides of the receptacle terminal 21.

Then, the PCB assembly is assembled with the housing 40 via the PCB bolt 50 and the housing bolt 60 at the PCB assembly part of the housing 40.

This assembly is accomplished by screw-fastening the PCB bolt 50 with the fastener 16 of the protector 10 and screw-fastening the housing bolt 60 with the compression limiter 17 of the protector 10. In this case, the PCB bolt 50 and the housing bolt 60 are fastened in directions orthogonal to each other.

This bolt fastening operation is performed in the same manner at two locations of the housing 40 using the left protector fixing device 15A and the right protector fixing device 15B.

Subsequently, the plug connector 30 is configured such that the terminal connection portion 31 is fitted into the protruding structure of the connector assembly guide 11b of the protector 10, thereby allowing the connector blade 33 to be fitted into the receptacle terminal 21 and to be connected to the connector board 20.

Referring to the assembled cross section of the receptacle connector 1 in FIG. 3 (cross-sectional view along line A-A in FIG. 2), the protector 10 and the connector board 20 may be assembled by fastening the screw 70.

During this fastening, the screw 70 has an end protected by the connector separation wall 11c while passing through the second receptacle terminal insertion port 14 of the protector 10.

As illustrated, the receptacle terminal 21 is located and protected within the first receptacle terminal insertion port 13 of the protector 10, and the plug connector 30 is configured such that the connector blade 33 is connected to the receptacle terminal 21 through a chamfered hole 13a perforated in the first receptacle terminal insertion port 13 of the protector 10.

In particular, the chamfered hole 13a widens a hole inlet into which the connector blade 33 enters to have a “V” cross-section, thereby improving the assembling efficiency of the connector blade 33 fitted into the receptacle terminal 21.

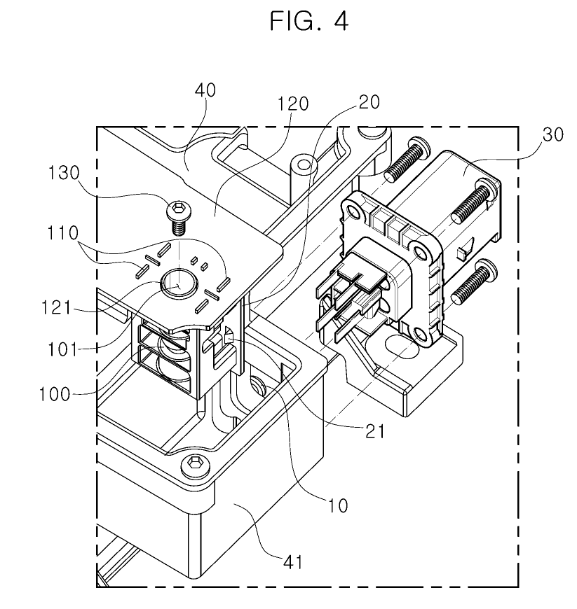

Meanwhile, FIG. 4 illustrates a component for a PCB terminal protection structure using a receptacle connector having a PCB terminal protector.

Specifically, the PCB terminal protection structure using the receptacle connector having the PCB terminal protector includes the protector 10, the connector board 20 having the receptacle terminal 21 of a receptacle terminal end portion 21a, the plug connector 30, the housing 40 having the connector connection housing 41, a busbar body 100, a busbar 110, a housing board 120, a busbar screw 130, and a guide 140. In this case, the guide 140 may be omitted depending on the structures and shapes of the protector 10 and the plug connector 30.

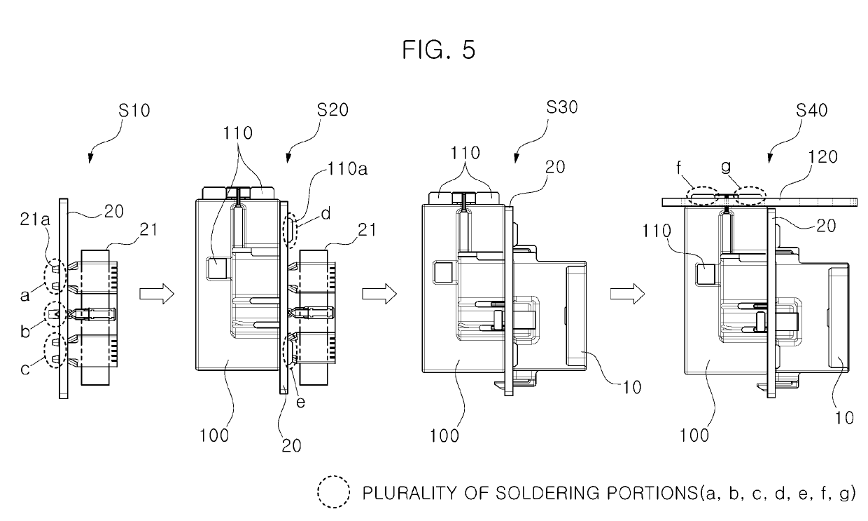

For example, the protector 10 and the plug connector 30 have the same structure as those illustrated in FIGS. 1 to 3, but the receptacle terminal 21 fitted into the connector board 20 has a difference in that the receptacle terminal end portion 21a protruding from the connector board 20 forms three soldering portions a, b, and c at upper, middle, and lower portions (see FIG. 5) of the connector board 20.

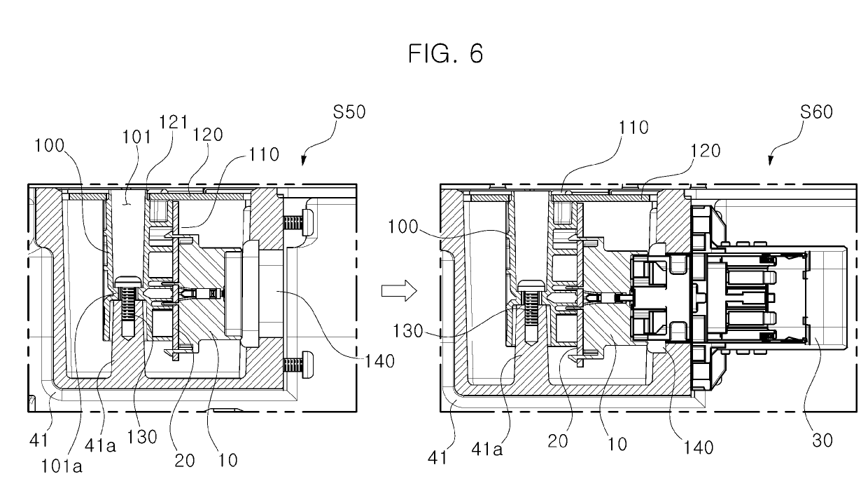

In addition, the housing 40 differs in that it further includes a connector connection housing 41, which protrudes from one side thereof and forms an internal space into which a screw insertion portion 101 (see FIG. 6) of the busbar body 100 is fitted having an internal space into which the busbar body 100 may be inserted.

In particular, a busbar positioning portion 41a may be further formed to fix a position of the busbar body 100 while being screw-fastened to the busbar screw 130 inserted into the internal space of the connector connection housing 41, and in addition, an opening into which a protruding portion of the protector 10 (i.e., a portion into which the receptacle terminal 21 is inserted) is inserted may be formed at one side of the connector connection housing 41, and the protector 10 may be fastened to the receptacle terminal 21 among the connector board 20, the receptacle terminal 21, and the busbar body 100 located in the internal space of the connector connection housing 41 as the integrated structure.

For example, the busbar body 100 is insert-molded together with the plurality of busbars 110 and fitted into the connector connection housing 41 of the housing 40, and in a central portion of the body that supports the side at which the busbars 110 are insert-molded, the hollow screw insertion portion 101, which has an upper portion fitted into a board hole 121 of the housing board 120 and a lower portion fitted into the busbar locating portion 41a protruding inside the connector connection housing 41 of the housing 40, is formed.

In particular, in the screw insertion portion 101, a screw catch portion 101a (see FIG. 6) is formed to protrude from an inner diameter thereof, such that only a threaded portion of the busbar screw 130 passes therethrough but a head portion of the busbar screw 130 is retained thereon.

In addition, the busbar 110 is configured as a plurality of busbars that are insert-molded at various locations of the busbar body 100, and the plurality of busbars include upper/lower busbars (or first and second busbars) in which busbar end portions 110a, which protrude from one side of the busbar insert-molded body 100 and are inserted into the connector board 20, form two soldering portions d and e (see FIG. 5) with the connector board 20, and left/right busbars (or third and fourth busbars) in which busbar end portions 110a, which protrude from an upper portion of the busbar insert-molded body 100 and are inserted into the housing board 120, form two soldering portions f and g (see FIG. 5) with the housing board 120. In this case, the number of busbars may vary depending on the upper/lower and left/right soldering locations.

For example, the housing board 120 is connected to an upper portion of the screw insertion portion 101 of the busbar body 100 by perforating the board hole 121 and is connected to the connector board 20 by forming the two soldering portions f and g (see FIG. 5) with the fitted busbar end portions 110a of the busbar 110 (i.e., the left/right busbar or the third and fourth busbar). In this case, the board hole 121 and the screw insertion portion 101 may form a fixing force through an interference-fit structure.

For example, the busbar screw 130 has the threaded portion passing through the screw retaining protrusion 101a in the screw insertion portion 101 of the busbar body 100 screw-fastened to a female screw hole formed in the busbar locating portion 41a of the connector connection housing 41, thereby fixing both the busbar body 100 and the housing board 120.

For example, the guide 140 is coupled to the protector 10 to guide the fastening direction of the plug connector 30, thereby facilitating assembly work for the plug connector 30. In this case, the guide 140 may not be used.

In addition, FIGS. 5 and 6 illustrate a method of assembling a PCB terminal using a receptacle connector having a PCB terminal protector according to the present disclosure.

Hereinafter, the plug connector 30 is described as being coupled at the connector coupling housing 41 protruding from one side of the housing 40, but since the structure of the housing 40 is merely illustrative, the coupling position may vary depending on the shape or structure of the housing 40.

Specifically, the method of assembling a PCB terminal using a receptacle connector having a PCB terminal protector includes assembling components illustrated in FIG. 5, such as the protector 10, the connector board 20, the busbar body 100, and the housing board 120 into an integrated component (10, 20, 100, 110, 120) (S10 to S40), which includes assembling the connector board 20 and the receptacle terminal 21 (S10), assembling the connector board 20 and the busbar body 100 having the busbar 110 (S20), assembling the receptacle terminal 21 and the protector 10 (S30), and assembling the busbar 110 and the housing board 120 (S40).

Subsequently, the integrated component is manufactured as a PCB terminal through housing assembly operations S50 and S60 illustrated in FIG. 6, which include fastening the busbar screw 130 (S50) and assembling the plug connector 30 (S60).

In this way, the method of assembling a PCB terminal using a receptacle connector having a PCB terminal protector includes first assembling the PCB terminal components, that is, the protector 10, the connector board 20, the busbar body 100, and the housing board 120, before assembling them into the housing 40, thereby forming the integrated component (10, 20, 100, 110, 120) and then assembling the housing 40 using the integrated component (10, 20, 100, 110, 120) as a single unit, thereby significantly improving work efficiency.

In particular, the integrated component (10, 20, 100, 110, 120) may use the protector 10 including the protector fixing device 15, the fastener 16, and the compression limiter 17, thereby solving all the problems of difficulty in improving assemblability between components due to the tolerance of a large number of connector-related components caused by the connector guide, the busbar assembly, the receptacle terminal, and the plurality of screws, which are existing components that need to be individually assembled and fastened to the housing.

For example, in the assembling of the connector board 20 and the receptacle terminal 21 (S10), the receptacle terminal 21 is fitted into a terminal hole (not illustrated) perforated in the connector board 20 such that the receptacle terminal end portion 21a of the receptacle terminal 21 protrudes toward the opposite side of the connector board 20, and the receptacle terminal end portion 21a is terminal-soldered to integrate the receptacle terminal 21 with the connector board 20.

To this end, the terminal soldering is performed while the connector board 20 is erected vertically, thereby forming three upper, middle, and lower terminal soldering portions a, b, and c, and the terminal soldering portions a, b, and c are exemplarily illustrated as three locations according to the number of receptacle terminals 21, but the number and locations thereof may vary depending on the number of receptacle terminals 21.

Subsequently, in the assembling of the connector board 20 and the busbar 110 (S20), the busbar body 100 is located on the terminal soldering portions a, b, and c of the connector board 20 to which the receptacle terminal 21 is fixed by soldering, the plurality of busbars 110 inserted into the busbar body 100 is inserted into a first busbar hole (not illustrated) perforated in the connector board 20, and the first busbar soldering of the busbar 110 is performed to integrate the busbar body 100 into the connector board 20 at the opposite side of the receptacle terminal 21.

To this end, in the first busbar soldering, among the plurality of busbars, the busbar end portions 110a protruding from the connector board 20 form two upper/lower first busbar soldering portions d and e, and the number and locations of the first busbar soldering portions may vary depending on the number of busbars 110.

Accordingly, the connector board 20, the receptacle terminal 21, and the busbar body 100 (i.e., the busbar 110) are integrated into a single component through the terminal soldering portions a, b, and c and the first busbar soldering portions d and e.

In addition, in the assembling of the receptacle terminal 21 and the protector 10 (S30), an integrated structure of the connector board 20, the receptacle terminal 21, and the busbar body 100 (i.e., the busbar 110) fixed by the soldering a, b, c, d, and e is located in the internal space of the connector connection housing 41, and then the protector 10 is assembled by inserting the first and second receptacle terminal insertion ports 13 and 14 into the receptacle terminal 21 fitted into the connector board 20.

Thereafter, in the assembling of the busbar 110 and the housing board 120 (S40), the board hole 121 is fitted into the screw insertion portion 101 of the busbar body 100 to locate the housing board 120 in the connector connection housing 41 of the housing 40, and then the second busbar soldering of the busbar 110 inserted into a second busbar hole (not illustrated) perforated in the connector board 20 is performed to integrate it with the upper portion of the busbar body 100.

To this end, the busbar body 100 is assembled by coupling the lower portion of the screw insertion portion 101 to the busbar locating portion 41a of the connector connection housing 41, and the second busbar soldering forms two left/right second busbar soldering portions f and g on the busbar end portions 110a protruding from the upper portion of the busbar body 100 among the plurality of busbars, and these second busbar soldering portions f and g may vary depending on the number of busbars 110.

Accordingly, among the connector board 20, the receptacle terminal 21, the busbar body 100, and the busbar 110 as the integrated structure, the busbar 110 is fixed to the housing board 120 by the soldering portions f and g.

Subsequently, in the fastening of the busbar screw 130 (S50), the screw portion of the busbar screw 130 passing through the screw retaining protrusion 101a within the internal space of the connector connection housing 41 is screw-fastened to the female screw hole of the busbar locating portion 41a, and the screw fastening is performed until the head portion of the busbar screw 130 comes into contact with the screw retaining protrusion 101a.

In addition, after the busbar screw 130 is fastened, the guide 140 may be connected to the protector 10 such that the plug connector 30 can be easily fastened. In this case, when the plug connector 30 can be easily assembled without interference with the housing 40 or peripheral components, the guide 140 may be removed.

Finally, in the assembling of the plug connector 30 (S60), the terminal connection portion 31 of the plug connector 30 is assembled with the protector 10 at the connector connection housing 41 side, such that the housing 40 to which the plug connector 30 is assembled is manufactured as a plug connector device for data communication with an external device or power supply from a power supply device.

The receptacle connector having the PCB terminal protector according to the present disclosure can include the protector fitted into the receptacle terminal and integrally formed with the connector board, thereby securing structural stability of the receptacle terminal that is disconnected from and connected to the plug connector and improving vibration resistance.

In addition, the PCB terminal protection structure using the receptacle connector having the PCB terminal protector according to the present disclosure can have the integrated structure including the connector guide to improve assemblability, thereby improving the assemblability of the connector-related components during assembly, and in particular, can assemble the connector board assembled with the board 1 as the integrated structure of the busbar, the receptacle terminal, and the connector guide, thereby achieving simplification of connector components.

As described above, in the receptacle connector 1 having a PCB terminal protector according to the present embodiment, the protector 10 coupled to the receptacle terminals 21 soldered to the connector board 20 is injection-molded together with the body 11 into which the receptacle terminals 21 are inserted and the left/right protector fixing devices 15A and 15B having mutually orthogonal bolt fastening directions, thereby improving vibration resistance through structural stability of the integrated structure of the protector 10 and the connector board 20, which surrounds the PCB-side receptacle terminals 21, and also improving assemblability with other components by the protector 10.

What is claimed is:

1. A printed circuit board (PCB) terminal protector, comprising:
a connector board; and
a protector for protecting a receptacle terminal of the connector board,
wherein the protector includes:
a protector fixing device of a body configured to protect the receptacle terminal;
a fastener configured to fasten the protector fixing device and the connector board; and
a compression limiter configured to fasten the protector fixing device and a housing in which the connector board is located.

2. The PCB terminal protector of claim 1, wherein the fastener and the compression limiter are fastened with bolts, respectively.

3. The PCB terminal protector of claim 1, wherein the fastener and the compression limiter are formed to have fastening directions orthogonal to each other.

4. The PCB terminal protector of claim 1, wherein the protector fixing device includes a left protector fixing device and a right protector fixing device formed on left and right sides of the body.

5. The PCB terminal protector of claim 1, wherein the body is formed with a PCB assembly guide which forms a gap with the connector board.

6. The PCB terminal protector of claim 1, wherein the body has a first receptacle terminal insertion port in a hole structure into which the receptacle terminal of the connector board is inserted.

7. The PCB terminal protector of claim 6, wherein a chamfered hole is formed in the first receptacle terminal insertion port.

8. The PCB terminal protector of claim 6, wherein an inlet of the first receptacle terminal insertion port is formed by extending a connector assembly guide from the body.

9. The PCB terminal protector of claim 6, wherein the body forms a second receptacle terminal insertion port, and
a receptacle terminal having a different specification from the receptacle terminal is inserted into the second receptacle terminal insertion port.

10. The PCB terminal protector of claim 9, wherein an outlet of the second receptacle terminal insertion port is formed by extending a connector separation wall of the body.

11. A receptacle connector comprising:
a connector board;
a protector located on one side of the connector board; and
a housing located on the other side of the connector board,
wherein the protector includes:
a left protector fixing device and a right protector fixing device of an body, which protect a receptacle terminal of the connector board;
an fastener configured to fasten the left protector fixing device and the right protector fixing device to the connector board; and
a compression limiter configured to fasten the left protector fixing device and the right protector fixing device to the housing,
wherein the fastener is coupled to a printed circuit board (PCB) bolt, and
wherein the compression limiter is coupled to a housing bolt.

12. The receptacle connector of claim 11, wherein the PCB bolt and the housing bolt are formed to have fastening directions orthogonal to each other.

13. The receptacle connector of claim 11, wherein the body has a first receptacle terminal insertion port in a hole structure into which the receptacle terminal of the connector board is inserted, and
a connector assembly guide surrounding a periphery of the first receptacle terminal insertion port is formed in a protruding structure.

14. The receptacle connector of claim 11, wherein a chamfered hole is formed in the first receptacle terminal insertion port.

15. A printed circuit board (PCB) terminal protection structure comprising:
a connector board in which a receptacle terminal and a busbar inserted into a busbar body are inserted and fixed by soldering;
a housing having a connector connection housing in which a busbar locating portion couples a screw insertion portion of the busbar body and protrudes from an internal space in which the connector board is accommodated;
a housing board in which the busbar is inserted and fixed by soldering at a portion of the connector connection housing; and
a busbar screw located in the screw insertion portion and screw-fastened to the busbar locating portion to fix the busbar body.

16. The PCB terminal protection structure of claim 15, wherein the connector board is connected to a plug connector, and
the plug connector is assembled to a protector connected to the receptacle terminal.

17. The PCB terminal protection structure of claim 15, wherein the busbar body forms a screw retaining protrusion in an internal space of the screw insertion portion, and
the screw retaining protrusion limits a screw fastening depth between the busbar screw and the busbar locating portion.

18. The PCB terminal protection structure of claim 15, wherein the housing board forms a board hole into which the screw insertion portion of the busbar body is fitted.

19. A method of assembling a printed circuit board (PCB) terminal using a receptacle connector having a PCB terminal protector, the method comprising:
forming an integrated component by coupling a busbar of a busbar body and a housing board with a connector board to which the busbar body is coupled together with a protector;
coupling the integrated component to a housing;
fastening a busbar screw to a connector connection housing in a screw insertion portion of the busbar body;
fixing the busbar body to the connector connection housing; and
assembling a plug connector to the protector.

20. The method of claim 19, wherein forming the integrated component includes:
inserting a receptacle terminal into the connector board such that a receptacle terminal end portion of the receptacle terminal, which protrudes from one side of the connector board, is fixed by soldering;
locating the busbar body on the connector board at a soldering portion of the receptacle terminal end portion, and fixing a busbar end portion of the busbar protruding from an opposite side of the connector board; and
assembling the protector with the receptacle terminal; and
fixing the housing board inserted into the busbar protruding from an upper portion of the busbar body to the busbar end portion.
